(19) United States
(12) Patent Application Publication
(10) Pub. No.: US 2009/0152786 A1
(43) Pub. Date: Jun. 18, 2009

(54) Clamping device

(75) Inventors: Kazuhide Iwata, Mino-shi (JP); Ryoji Baba, Mino-shi (JP); Hitoshi Mabuchi, Mino-shi (JP)

Correspondence Address: JORDAN AND HAMBURG LLP, 122 EAST 42ND STREET, SUITE 4000, NEW YORK, NY, 10168, US

(73) Assignee: Kabushiki Kaisha Imao Corporation, Seki-shi (JP)

(21) Appl. No.: 12/316,656

(22) Filed: Dec. 15, 2008

(30) Foreign Application Priority Data
Dec. 14, 2007 (JP) 2007-323722
Apr. 28, 2008 (JP) 2008-117901

(51) Int. Cl. B25B 5/16

(52) U.S. Cl. 269/89

(57) ABSTRACT

A clamping device that can reduce a burden on a worker and can surely fix an object includes a basic body, a pressing section for pressing a workpiece, a manually operable operating section, and a transmitting body. The transmitting body transmits a movement of the operating section to the pressing section so that the pressing section travels between a pressing position, at which the pressing section presses the workpiece, and a standing-by position, at which the pressing section is spaced apart from the workpiece to stand by. The basic body has a second opposing section opposing a first opposing section which belongs to the transmitting body. The second opposing section has a pressurizing member resiliently urged in a direction in which the pressurizing member goes from the second opposing section toward the first opposing section. The first opposing section has a pressurized surface which the pressurizing member pressurizes. The pressurized surface has a first depression which the pressurizing member is on the point of entering when the pressing section is placed at the pressing position.

### BACKGROUND OF THE INVENTION

This invention relates to a clamping device for fixing an object, such as a workpiece.

Conventionally, a toggle clamp used as a clamping device for easily fixing a workpiece as an object to a fixture base or the like is known (for example, see MISUMI Catalog, Jigs and Fixtures Standard Components 1991-1992, Pages 335-354). The toggle clamp has a linkage mechanism converting the force of a hand which operates an operating section provided on a lever to the force for pressing the object. The toggle clamp clamps the object through the linkage mechanism.

Attendant with such use, however, because the conventional toggle clamp generates the force for pressing the workpiece as the object by the force of the hand, the force generating work burdens the worker. Also, because, with the toggle clamp, the worker needs to press the lever up to the clamp completion position, a pressing state of the lever provided by the worker exerts influence on a fixed (clamp) state of the workpiece and the pressing state can bring an unfavorable fixed state of the workpiece.

This invention is made for solving the conventional drawback noted above.

An object thereof is to provide a clamping device that can reduce a burden on a worker and can surely fix an object.

### SUMMARY OF THE INVENTION

A clamping device configured in accordance with this invention has the following construction to achieve the object.

According to an aspect of the invention, the clamping device of the invention for fixing an object includes a basic body, a pressing section for pressing the object, a manually operable operating section, and a transmitting body. The transmitting body is mounted to the basic body for transmitting a movement of the operating section to the pressing section so that the pressing section travels between a pressing position, at which the pressing section presses the object, and a standing-by position, at which the pressing section is spaced apart from the object to stand by. The basic body has a second opposing section opposing to a first opposing section which belongs to the transmitting body in a direction normal to a direction in which the first opposing section moves. One of the first opposing section or the second opposing section has a pressurizing member resiliently urged in a direction in which the pressurizing member goes from the one of the first or second opposing sections toward the remaining opposing section. The remaining opposing section has a pressurized surface which the pressurizing member pressurizes. The pressurized surface has a first depression which the pressurizing member is on the point of entering when the pressing section is placed at the pressing position, the first opposing section receiving the force generated by the pressurizing member that is on the point of entering the first depression so that the pressing section is urged to a side on which the pressing section presses the object.

According to the clamping device, in order to fix an object, first the object is placed at a fixed position. Then, the operating section is operated to move the pressing section to the pressing position from the standing-by position through the transmitting body. At the pressing position, the first opposing section of the transmitting body receives the force by which the resiliently urged pressurizing member is on the point of entering the first depression provided on the pressurized surface. Thereby, the pressing section is urged to a side on which the pressing section presses the object. Thus, by the urging force, the pressing section presses the object to fix the object.

Regarding the clamping device according to a further aspect of the invention, the pressurized surface has a second depression which the pressurizing member enters when the pressing section is placed at the standing-by position. Because the resiliently urged pressurizing member enters the second depression when the pressing section is placed at the standing-by position, the pressing section is held at the standing-by position.

In accordance with a further feature of the invention, the pressing section and the operating section are unitarily formed with the transmitting body. The transmitting body is supported by the basic body for pivotal movement so that the pressing section travels between the pressing position and the standing-by position.

According to another feature of the clamping device of the invention, the second opposing section is the one opposing section and the first opposing section is the remaining opposing section. The transmitting body has the first opposing sections, each of which has the pressurized surface, on both sides thereof which are symmetrically positioned to each other. The basic body has the second opposing sections, each of which has the pressurizing member, corresponding to the first opposing sections. Because the first opposing sections, each of which has the pressurized surface, are placed on both sides of the transmitting body which are symmetrically positioned to each other, and the second opposing sections, each of which has the pressurizing member, are placed onto the basic body corresponding to the first opposing sections, the balance of the transmitting body receiving the force of the pressurizing members is maintained and the transmitting body moves smoothly. In addition, because such two pairs of the pressurized surfaces and the pressurizing members are provided, the force by which the pressing section presses the object can be greater, to strongly fix the object.

Regarding a further aspect of the clamping device according to the invention, the transmitting body has a bar including the pressing section at an end thereof, and a lever including the operating section at an end thereof. The bar is supported by the basic body for slide movement so that the pressing section travels between the pressing position and the standing-by position. The lever is mounted to the basic body for pivotal movement. A converting mechanism arranged to convert the pivotal movement of the lever to the slide movement of the bar is placed between the lever and the bar.

According to yet another aspect of the clamping device of the invention, the second opposing section is the one opposing section and the first opposing section is the remaining opposing section. The bar has the first opposing sections, each of which has the pressurized surface, on both sides thereof which are symmetrically positioned to each other. The basic body has the second opposing sections, each of which has the pressurizing member, corresponding to the first opposing sections. Because the first opposing sections, each of which has the pressurized surface, are placed on both sides of the bar which are symmetrically positioned to each other, and the second opposing sections, each of which has the pressurizing member, are placed onto the basic body in correspondence to the first opposing sections, the balance of the bar receiving the force of the pressurizing member is maintained, and the bar moves smoothly. In addition, because such two pairs of the pressurized surfaces and the pressurizing members are provided, the force by which the pressing section presses the object can be greater, to strongly fix the object.

Regarding a further aspect of the clamping device according to the invention, the pressurized surface has a groove extending between the first depression and the second depression to serve as a guide for the pressurizing member, and the groove is sloped so as to be deeper as the groove becomes closer to the second depression than to the first depression.

Regarding another aspect of the clamping device of the invention, the first opposing section and the second opposing section oppose each other in a radial direction of a circle made about an axis around which the transmitting body is supported by the basic body for pivotal movement.

Regarding the clamping device of the invention which provides a further aspect, the second opposing section is the one opposing section and the first opposing section is the remaining opposing section, and the pressurizing member is resiliently urged by a coil spring.

Regarding yet another aspect of the clamping device of the invention, the basic body includes a body part and a mount part extending from the body part and screwed onto a fixing base, and a holding hollow for holding the pressurizing member and the coil spring extends through the body part and the mount part. Because the holding hollow extends through the body part and the mount part, and the pressurizing member and the coil spring is inserted into the holding hollow, the mount part screwed into the fixing base can be effectively used. Thereby, the clamping device can be downsized.

According to the clamping device of this invention, because the force for pressing the object is generated using the force by which the pressurizing member, which is resiliently urged, is on the point of entering the first depression, the burden on a worker can be reduced. Also, the pressing section automatically moves to the pressing position to press the object because the pressurizing member, which is resiliently urged, is on the point of entering the first depression when the operating section is operated to move the pressing section to the pressing position. Therefore, the object can be surely fixed.

With reference to drawings, the preferred embodiments carrying out the clamping device of this invention will be described below.

### BRIEF DESCRIPTION OF THE DRAWINGS

FIG. 1 is an oblique view of a clamping device configured in accordance with a first embodiment;

FIG. 2 is an exploded oblique view of the clamping device shown in FIG. 1;

FIG. 3 is a vertical cross sectional view of the clamping device when a pressing section is placed between a pressing position and a standing-by position;

FIG. 4 is a cross sectional view taken along the line A-A of FIG. 3;

FIG. 5 is an enlarged cross sectional view taken along the line B-B of FIG. 3;

FIG. 6 is a vertical cross sectional view of the clamping device when the pressing section is placed at the pressing position;

FIG. 7 is an enlarged cross sectional view taken along the line C-C of FIG. 6;

FIG. 8 is a vertical cross sectional view of the clamping device when the pressing section is placed at the standing-by position;

FIG. 9 is an enlarged cross sectional view taken along the line D-D of FIG. 8;

FIG. 10 is an oblique view of a clamping device configured in accordance with a second embodiment;

FIG. 11 is an exploded oblique view of the clamping device shown in FIG. 10;

FIG. 12 is a vertical cross sectional view of the clamping device when the pressing section is placed at the pressing position;

FIG. 13 is a cross sectional view taken along the line E-E of FIG. 12;

FIG. 14 is a vertical cross sectional view of the clamping device when the pressing section is placed at the standing-by position;

FIG. 15 is a cross sectional view taken along the line F-F of FIG. 14;

FIG. 16 is an oblique view of a clamping device configured in accordance with a third embodiment;

FIG. 17 is an exploded oblique view of the clamping device shown in FIG. 16;

FIG. 18 is a vertical cross sectional view of the clamping device when the pressing section is placed at the pressing position;

FIG. 19 is an enlarged view showing a principal portion of FIG. 18;

FIG. 20 is a vertical cross sectional view of the clamping device when the pressing section is placed at the standing-by position;

FIG. 21 is an enlarged view showing a principal portion of FIG. 20; and

FIG. 22 is an oblique view showing a variation of the first embodiment.

### DETAILED DESCRIPTION OF THE INVENTION

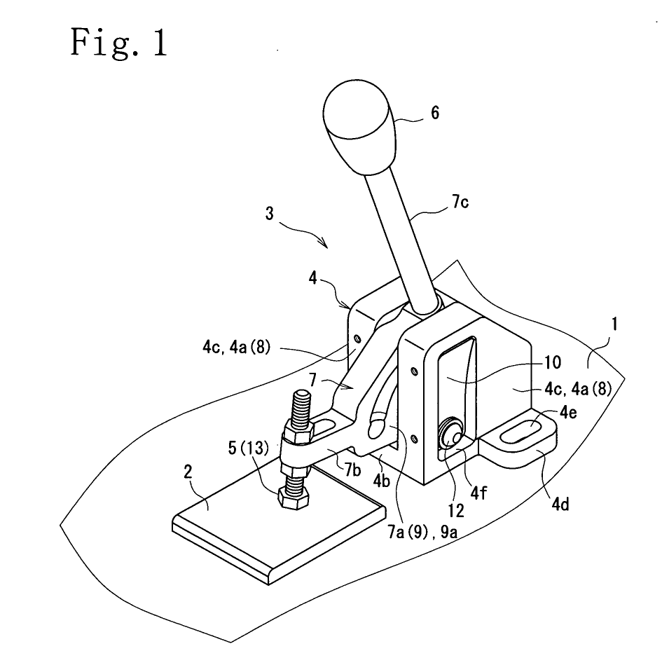

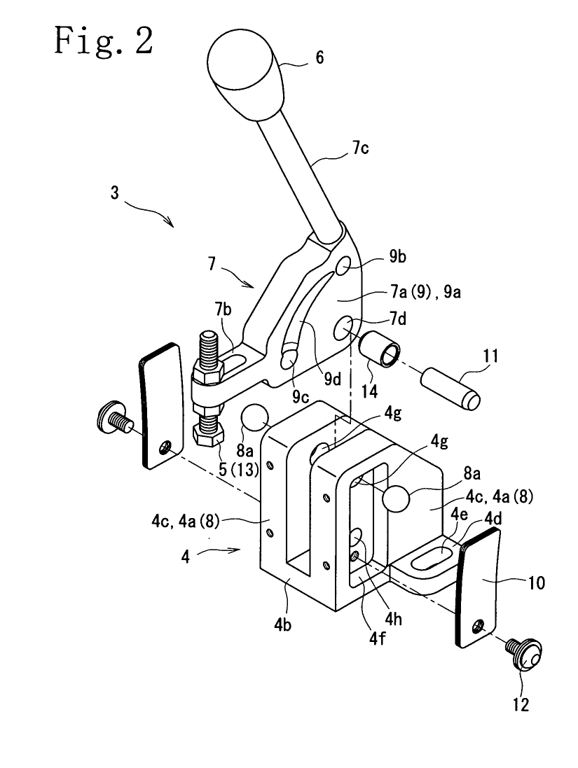

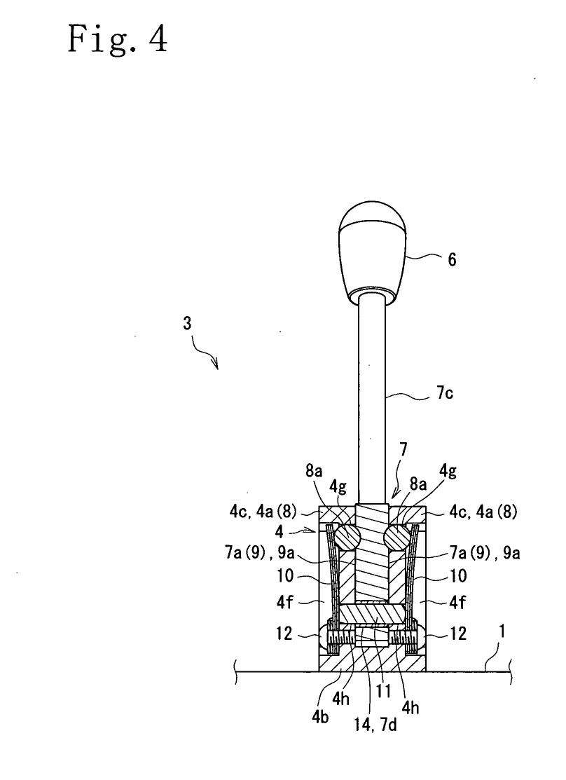

FIGS. 1-9 depict a first embodiment of this invention. The reference numeral 1 in these figures designates a fixing base. A workpiece, as an object, is designated by reference numeral 2. A clamping device for fixing the workpiece 2 to the fixing base 1 is generally designated by the reference numeral 3.

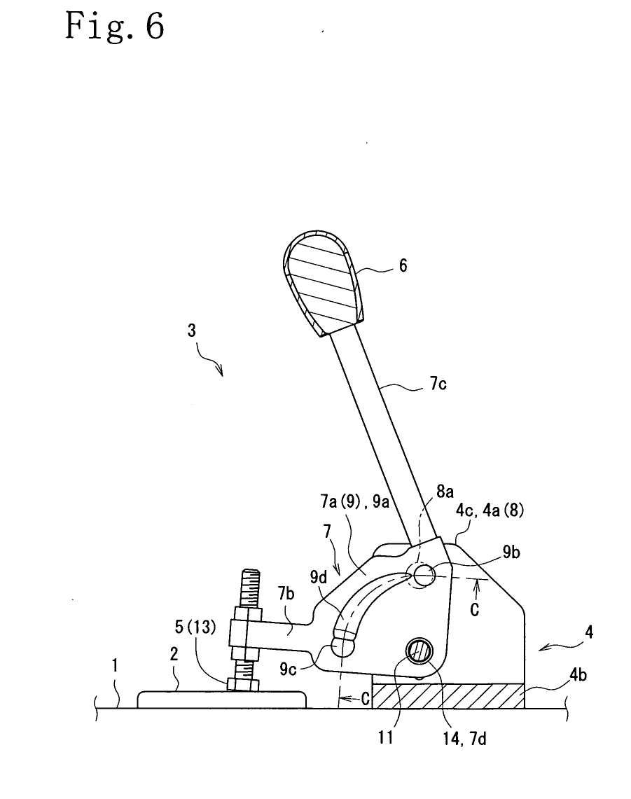

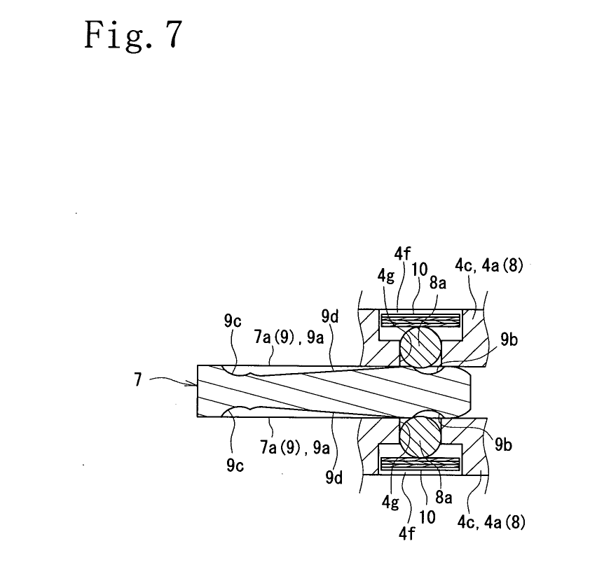

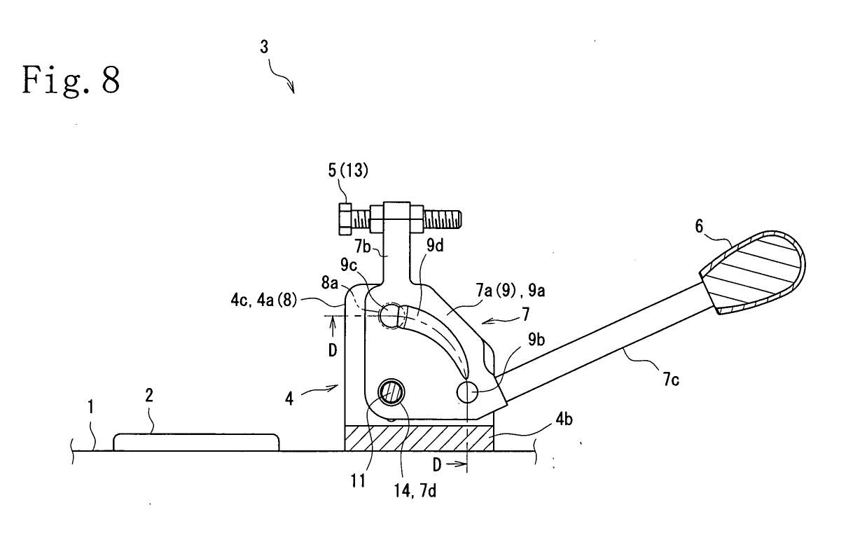

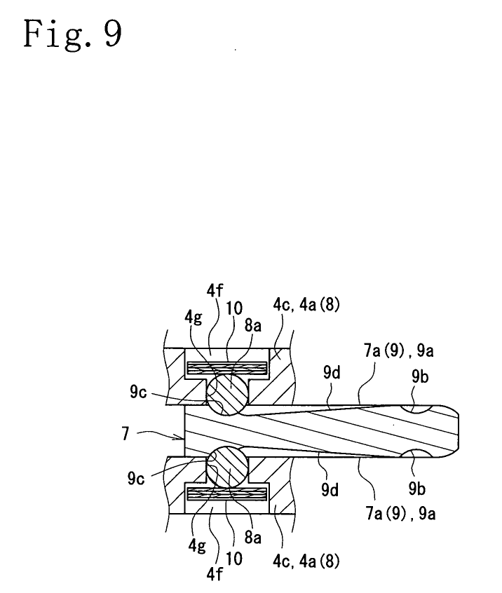

The clamping device 3 includes a basic body 4, a pressing section 5 for pressing the workpiece 2, a manually operable operating section 6, and a transmitting body 7. The transmitting body 7 is mounted to the basic body 4 for transmitting a movement of the operating section 6 to the pressing section 5, so that the pressing section 5 travels between a pressing position, at which the pressing section 5 presses the workpiece 2 (see FIGS. 6 and 7), and a standing-by position, at which the pressing section 5 is spaced apart from the workpiece 2 to stand by (see FIGS. 8 and 9).

The transmitting body 7 includes a first structural portion defining first opposing sections 7a. The basic body 4 includes a second structural portion defining second opposing sections 4a opposing the first opposing sections 7a in a direction normal to a direction in which the first opposing sections 7a move. An opposing section 8, which is one of the first structural portion defining the first opposing section 7a or the second structural portion defining the second opposing section 4a, includes a pressurizing member 8a resiliently urged in a direction in which the pressurizing member 8a goes from the one opposing section 8 toward a remaining opposing section 9. The remaining opposing section 9 includes a pressurized surface 9a which the pressurizing member 8a pressurizes. The pressurized surface 9a includes a first depression 9b which the pressurizing member 8a is on the point of entering when the pressing section 5 is placed at the pressing position. Each first opposing section 7a of the transmitting body 7 receives the force generated by the pressurizing member 8a that is on the point of entering the first depression 9b, so that the pressing section 5 is urged to a side on which the pressing section 5 presses the workpiece 2 (see FIGS. 6 and 7). Each pressurized surface 9a includes a second depression 9c which the pressurizing member 8a enters when the pressing section 5 is placed at the standing-by position (See FIGS. 8 and 9).

In the embodiment shown in FIGS. 1-9, the pressing section 5 and the operating section 6 are unitarily formed with the transmitting body 7. The transmitting body 7 is supported by the basic body 4 for pivotal movement so that the pressing section 5 travels between the pressing position and the standing-by position. Thereby, the operating section 6 and the pressing section 5 pivot in unison through the transmitting body 7. Because of the pivotal movement, the pressing section 5 travels between the pressing position and the standing-by position. Each second opposing section 4a, which belongs to the basic body 4, functions as the one opposing section 8, and each first opposing section 7a which belongs to the transmitting body 7 functions as the remaining opposing section 9. That is, the second opposing section 4a of the basic body 4 has the pressurizing member 8a, which is resiliently urged, and the first opposing section 7a of the transmitting body 7 includes the pressurized surface 9a, which is pressurized by the pressurizing member 8a. More in detail, the transmitting body 7 has the first opposing sections 7a, each of which has the pressurized surface 9a on both sides thereof which are symmetrically positioned to each other. The basic body 4 includes the second opposing sections 4a, each of which includes the pressurizing member 8a, in correspondence to the first opposing sections 7a, 7a.

Specifically, the fixing base 1 has a board shape. The basic body 4 is mounted and fixed to the fixing base 1 so that the clamping device 3 is mounted to the fixing base 1.

Regarding the clamping device 3, the basic body 4 has a bottom plate section 4b and a pair of rising sections 4c, 4c rising from the bottom plate section 4b and spaced apart from each other so as to oppose one another. Thus, the basic body 4 is formed to have an approximate U-shape. The basic body 4 includes flange sections 4d, 4d protruding sideward, and used for purposes of attachment. Each flange section 4d has an aperture 4e into which a fixing bolt may be inserted to mount and fix the basic body 4 to the fixing base 1.

Regarding the basic body 4, the rising sections 4c function as the second opposing sections 4a. Each rising section 4c is provided with the pressurizing member 8a which is comprised of, for example, a steel ball. More specifically, each rising section 4c includes a holding depression 4f in an outer side surface thereof. A leaf spring 10, as a resilient member, is held in the holding depression 4f. A pressurizing member holding aperture 4g, into which the pressurizing member 8a is inserted, and a shaft aperture 4h, which supports a shaft 11, are pierced through the holding depression 4f of the rising sections 4c so that an inner side and an outer side of each rising section 4c can communicate with one another. One end of the leaf spring 10, which is held in the holding depression 4f, is fastened by a screw 12. Thus, the other end of the leaf spring 10 resiliently urges the pressurizing member 8a, which is inserted into the pressurizing member holding aperture 4g. Also, a mid portion of each leaf spring 10 prevents the shaft 11 extending through both the shaft apertures 4h, 4h from coming off.

The transmitting body 7 has a fan-like plate shape. An arm 7b protrudes from one side of the fan shape, and an operating lever 7c is fixed to the other side. A screw 13 which forms the pressing section 5 is attached and fixed to the arm 7b. An end of the operating lever 7c has the operating section 6 which is formed with a knob. A shaft aperture 7d into which the shaft 11 is inserted extends through a center position of the fan shape. The transmitting body 7 is placed between the rising sections 4c, 4c of the basic body 4. The basic body 4 supports the transmitting body 7 for pivotal movement through the shaft 11. More in detail, a bush 14 is inserted into the shaft aperture 7d. Then, the shaft 11 is inserted into the bush 14. Thereby, the transmitting body 7 is supported by the basic body 4 for pivotal movement through the bush 14 and the shaft 11.

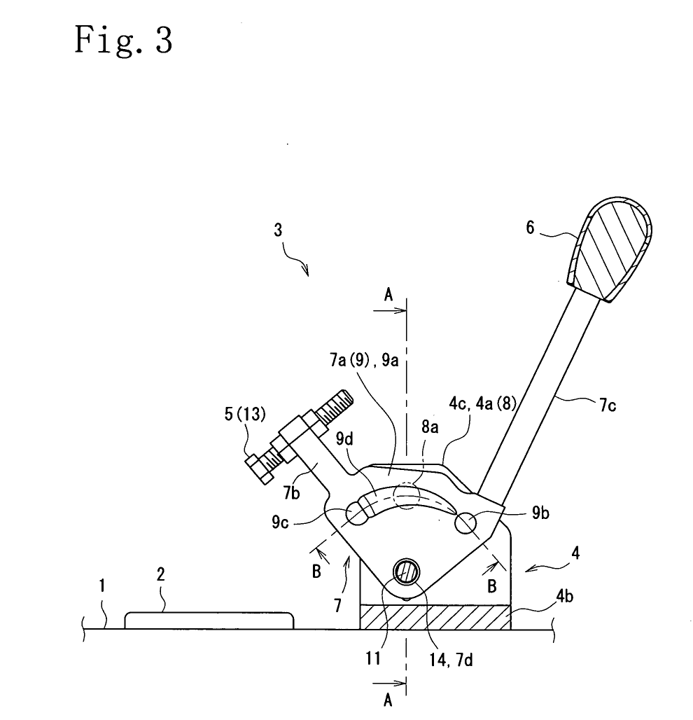

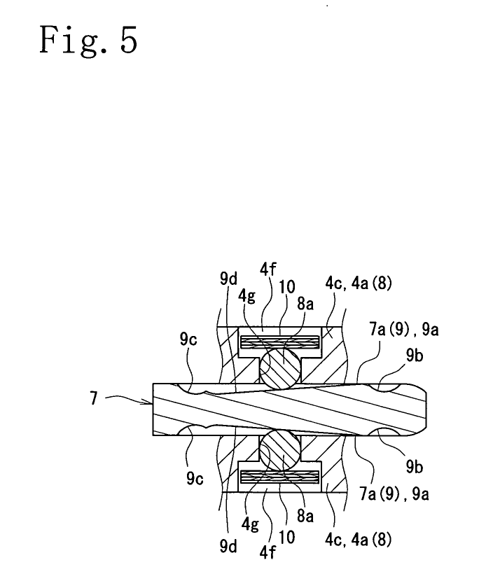

Both sides of the transmitting body 7 function as the first pressing sections 7a, 7a. Meanwhile, each arcuate portion of the transmitting body 7 around the shaft aperture 7d functions as the pressurized surface 9a, which has the first depression 9b and the second depression 9c. As shown in FIGS. 3 and 5, the pressurized surface 9a has a groove 9d extending between the first depression 9b and the second depression 9c to be a guide for the pressurizing member 8a in addition to the first depression 9b and the second depression 9c. The groove 9d is sloped so as to be deeper as the groove 9d becomes closer to the second depression 9c than to the first depression 9b.

Next, actions and effects of the clamping device 3 shown as the first embodiment will be described below. According to the clamping device 3, a workpiece 2 can be fixed in the following processes. The workpiece 2 is placed at a position in the fixing base 1 where the workpiece 2 is going to be fixed, the operating section 6 is operated (specifically, pivotally operated counterclockwise), and the pressing section 5 is moved from the standing-by position (see FIGS. 8 and 9) to the pressing position (see FIGS. 6 and 7) through the transmitting body 7. At the pressing position, the first opposing sections 7a of the transmitting body 7 receive the force generated by the pressurizing members 8a that are resiliently urged and are on the point of entering the first depressions 9b which belong to the pressurized surfaces 9a. Thereby, the pressing section 5 is urged to the side on which the pressing section 5 presses the workpiece 2. The pressing section 5 presses the workpiece 2 with the urging force so that the workpiece 2 is fixed to the fixing base 1.

When the pressing section 5 is placed at the pressing position, the pressing section 5 is urged to the side on which the pressing section 5 presses the workpiece 2 using the force by which the pressurizing members 8a, which are resiliently urged, are on the point of entering the first depressions 9b. As a result, the force by which the workpiece 2 is pressed can be kept constant regardless of any magnitude of the force generated by the hand operating the operating section 6. Also, the following effect can be expected. Because the conventional toggle clamp generates the force for pressing a workpiece by the force of a hand, the force generating work creates a burden for the worker. However, this burden can be reduced with the clamping device 3, because the clamping device 3 generates the force that presses the workpiece 2 using the force generated by the pressurizing members 8a that are resiliently urged by the leaf springs 10 and are on the point of entering the first depressions 9b (i.e., using the resilient force of the leaf springs 10). In addition, when the pressing section 5 is moved to the pressing position with the operation of operating section 6, the pressurizing members 8a, which are resiliently urged, are on the point of entering the first depressions 9. Thereby, the pressing section 5 automatically moves to the pressing position to press the workpiece 2. Thus, the workpiece 2 can be surely fixed (clamped).

The transmitting body 7 includes the first opposing sections 7a, 7a, each of which has the pressurized surface 9a, 9a, on both sides thereof which are symmetrically positioned to each other. The basic body 4 includes the second opposing sections 4a, 4a, each of which has the pressurizing member 8a, in corresponding to the first opposing sections 7a, 7a. Therefore, the balance of the transmitting body 7 receiving the force of the pressurizing members 8a, 8a is kept and the transmitting body 7 moves smoothly. In addition, because such two pairs of the pressurized surfaces 9a and the pressurizing members 8a are provided, the force by which the pressing section 5 presses the workpiece 2 can be larger to strongly fix the workpiece 2 to the fixing base 1.

On the other hand, the workpiece 2 can be removed from the fixing base 1 in the following processes. The operating section 6 is operated in the reverse direction (specifically, pivotally operated clockwise), the pressing section 5 is moved (specifically, pivoted) from the pressing position to the standing-by position through the transmitting body 7, and the workpiece 2 is removed from the fixing base 1. When the pressing section 5 is placed at the standing-by position, the pressurizing members 8a, which are resiliently urged, enter the second depressions 9c. Thereby, the pressing section 5 is kept at the standing-by position (see FIGS. 8 and 9).

Each groove 9d formed in the respective pressurized surface 9a of the transmitting body 7 is sloped so as to be deeper as the groove 9d becomes closer to the second depression 9c than to the first depression 9b. In other words, each groove 9d is sloped so as to be shallower as the groove 9d becomes closer to the first depression 9b than to the second depression 9c. Therefore, in the process that the operating section 6 is operated to move the pressing section 5 from the standing-by position (see FIGS. 8 and 9) to the pressing position (see FIGS. 6 and 7), the leaf springs 10 (resilient members) gradually bend. Hence, the load exerted on the hand can be lessened in comparison with a situation such that the leaf springs 10 (resilient members) largely bend already when the pressing section 5 is at the standing-by position.

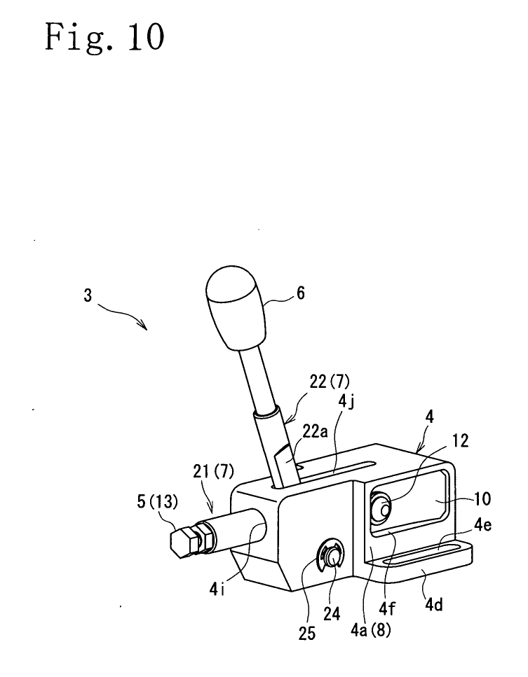

FIGS. 10-15 show a second embodiment of this invention. A clamping device 3 in this embodiment differs from the clamping device 3 in the first embodiment mainly in connection with a construction of the transmitting body 7. Because the other basic constructions are similar to those in the first embodiment, sections and members having the same functions will be assigned the same reference numerals and symbols, and different portions will be mainly described below.

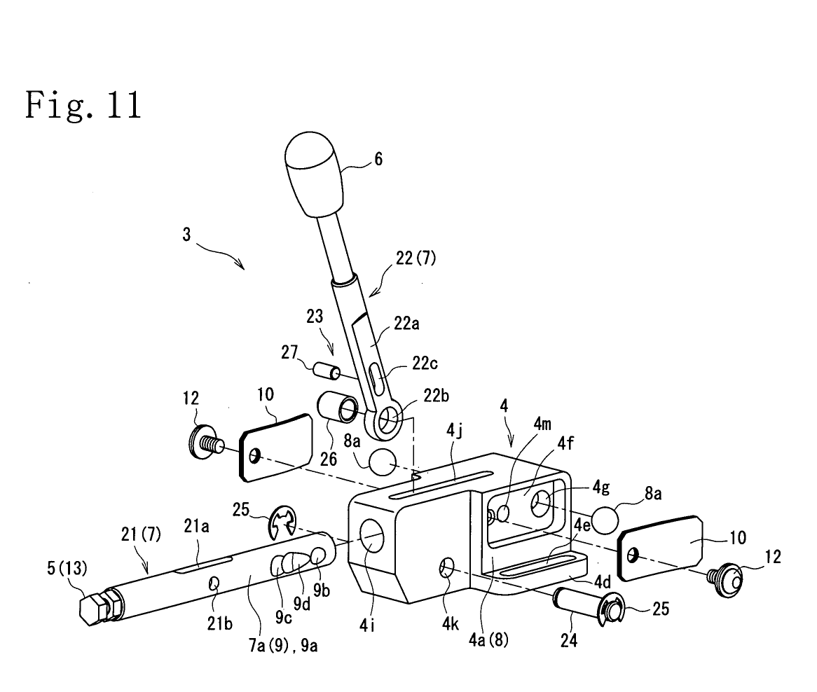

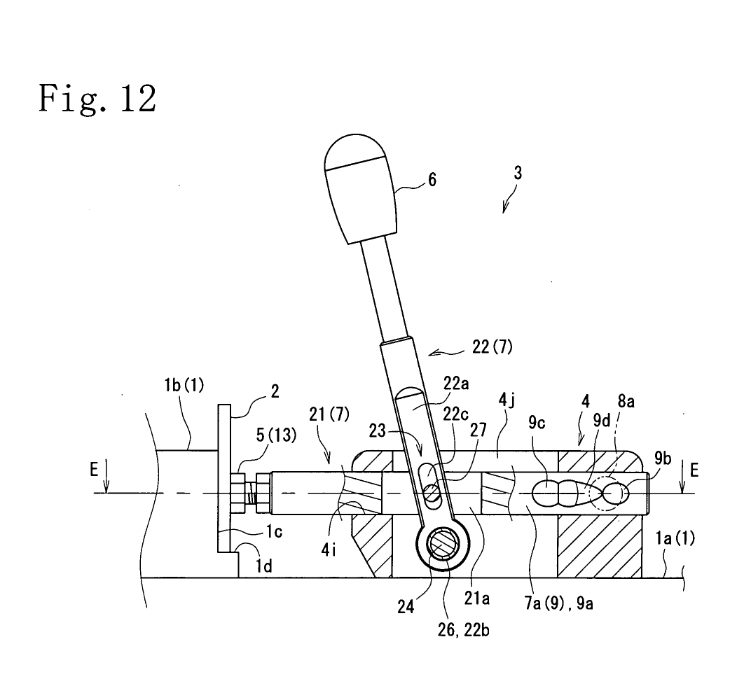

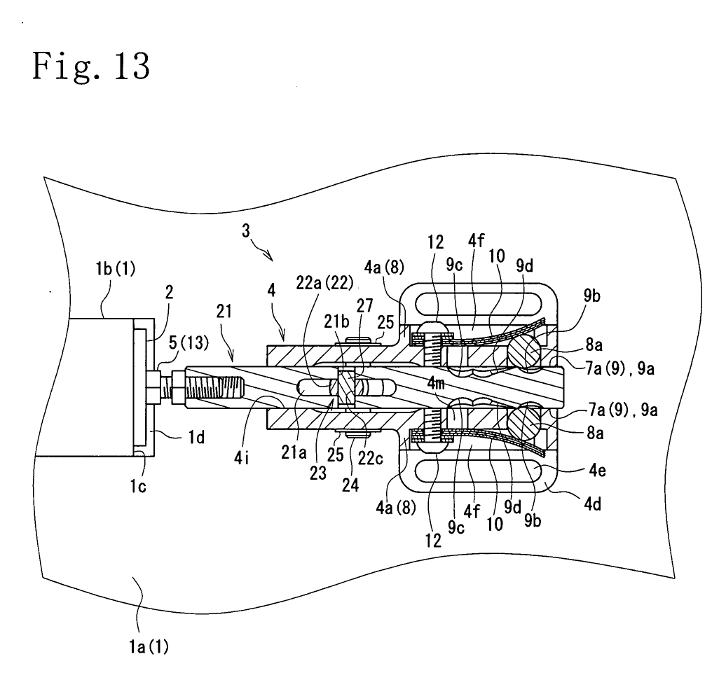

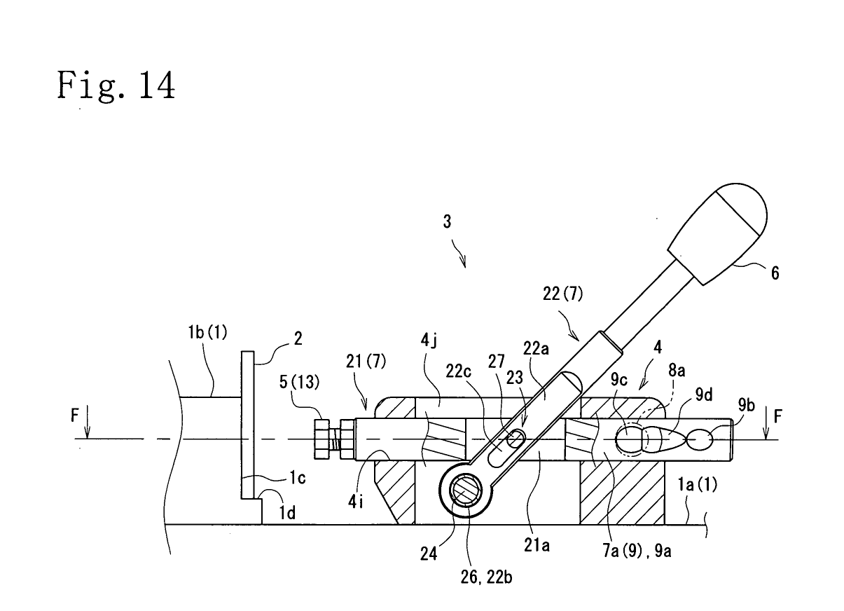

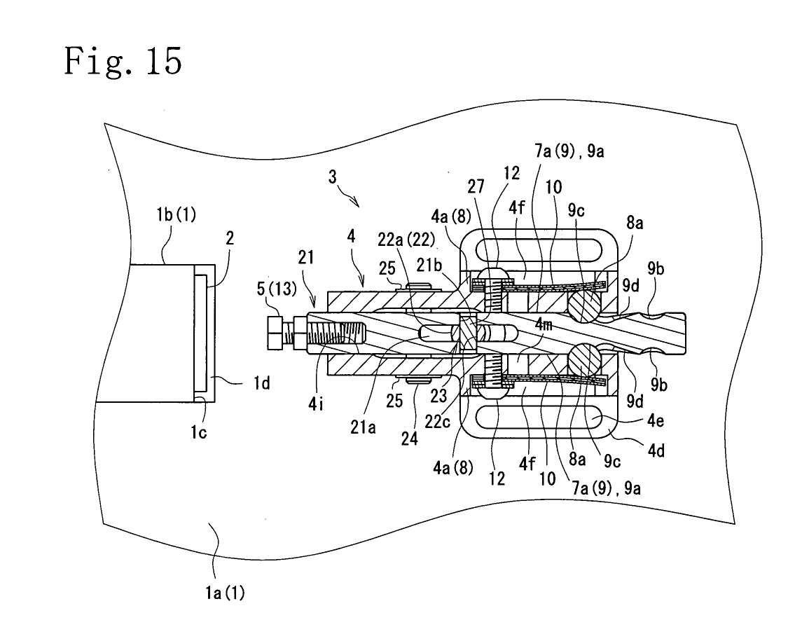

FIG. 10 is an oblique view of the clamping device 3. FIG. 11 is an exploded oblique view of the clamping device 3. FIG. 12 is a vertical cross-sectional view of the clamping device 3 when the pressing section 5 is placed at the pressing position and corresponds to FIG. 6 of the first embodiment. FIG. 13 is a cross sectional view taken along the lines E-E of FIG. 12. FIG. 14 is a vertical cross-sectional view of the clamping device 3 when the pressing section 5 is placed at the standing-by position and corresponds to FIG. 8 of the first embodiment. FIG. 15 is a cross sectional view taken along the lines F-F of FIG. 14.

A transmitting section 7 has a bar 21 including a pressing section 5 at an end thereof, and a lever 22 including an operating section 6 at an end thereof. The bar 21 is supported by a basic body 4 for slide movement so that the pressing section 5 travels between a pressing position (see FIGS. 12 and 13) at which the pressing section 5 presses a workpiece 2 as an object, and a standing-by position (see FIGS. 14 and 15) at which the pressing section 5 is separated from the workpiece 2 and stands by. The lever 22 is mounted to the basic body 4 for pivotal movement. A converting mechanism 23 is placed between the lever 22 and the bar 21 to convert the pivotal movement of the lever 22 to the slide movement of the bar 21. Similarly to the first embodiment, each second opposing section 4a which belongs to the basic body 4 functions as one opposing section 8, and each first opposing section 7a which belongs to the transmitting body 7 functions as the remaining opposing section 9. That is, the second opposing section 4a of the basic body 4 has the pressurizing member 8a, which is resiliently urged, and the first opposing section 7a of the transmitting body 7 has the pressurized surface 9a, which is pressurized by the pressurizing member 8a. More specifically, the bar 21 forming the transmitting body 7 includes the first opposing sections 7a, 7a, each of which has the pressurized surface 9a, 9a, on both sides thereof which are symmetrically positioned to each other. The basic body 4 includes the second opposing sections 4a, each of which has the pressurizing member 8a, corresponding to the first opposing sections 7a, 7a.

Similarly to the first embodiment, each pressurized surface 9a has a first depression 9b which the pressurizing member 8a is on the point of entering when the pressing section 5 is placed at the pressing position. Each first opposing section 7a receives the force generated by the pressurizing member 8a that is on the point of entering the first depression 9b, and the pressing section 5 is urged to the side on which the pressing section 5 presses the workpiece 2 (see FIGS. 12 and 13). The pressurized surface 9a also has a second depression 9c which the pressurizing member 8a enters when the pressing section 5 is placed at the standing-by position (see FIGS. 14 and 15).

Specifically, the fixing base 1 is formed with a main base 1a having a board shape and an auxiliary base 1b fixed to the main base 1a. The basic body 4 is mounted and fixed to the main base 1a of the fixing base 1 so that the clamp 3 is mounted to the main base 1a. The clamping device 3 fixes the workpiece 2 to the auxiliary base 1b of the fixing base 1. More in detail, the auxiliary base 1b has a receiving surface 1c extending vertically relative to a top surface of the main base 1a to receive the workpiece 2, and a positioning surface 1d extending normal to the receiving surface 1c to position the workpiece 2.

Regarding the clamping device 3, the basic body 4 generally has a rectangular parallelepiped shape which has a longitudinal axis extending in a fore to aft direction. The basic body 4 has flange sections 4d, 4d protruding sideward and which are used for attaching purposes. Each flange section 4d has an aperture 4e into which a fixing bolt can be inserted to mount and fix the basic body 4 to the fixing base 1 (specifically, the main base 1a).

A guide hollow 4i is extended through the basic body 4 fore to aft. The bar 21 is inserted into the guide hollow 4i for slide movement fore to aft. Right and left side portions of the basic body 4 interposing the guide hollow 4i therebetween function as the second opposing sections 4a. Each side portion is provided with the pressurizing member 8a which is made of, for example, a steel ball. More specifically, a rear area of each right/left side portion has a holding depression 4f in an outer side surface thereof. A leaf spring 10 as a resilient member is held in the holding depression 4f. A pressurizing member holding aperture 4g into which the pressurizing member 8a is inserted is inwardly directed at the holding depression 4f of each outer side portions so that each pressurizing member holding aperture 4g communicates to the guide hollow 4i. One end of the leaf spring 10, which is held in the holding depression 4f, is fastened by a screw 12. Thus, the other end of the leaf spring 10 resiliently urges the pressurizing member 8a, which is inserted into the pressurizing member holding aperture 4g.

A slit 4j extends through the basic body 4 from top to bottom thereof. The slit 4j extends in such a manner that a fore-to-aft length thereof is longer than a top-to-bottom length thereof. A front area of the right and left side portions of the basic body 4 is narrowed. A shaft aperture 4k which supports a shaft 24 is provided through the front area to communicate with the guide hollow 4i. Additionally, the reference numeral 4m indicates an aperture used for setting a pin 27 described later. Also, the reference numeral 25 indicates a snap ring which prevents the shaft 24 from detaching.

The bar 21 extends fore to aft. A screw 13 forming the pressing section 5 is attached and fixed to an end of the bar 21. Both of right and left side surfaces of the bar 21 function as the first opposing sections 7a, 7a, while, particularly, rear portions of the side surfaces function as the pressurized surfaces 9a. Similarly to the first embodiment, each pressurized surface 9a has the first depression 9b, the second depression 9c, and further a groove 9d extending between the first depression 9b and the second depression 9c to be a guide for the pressurizing member 8a. The groove 9d is sloped so as to be deeper as the groove 9d becomes closer to the second depression 9c than to the first depression 9b.

A slit 21a extends through the bar 21 from top to bottom thereof. The slit 21a extends in such a manner that a fore-to-aft length thereof is longer than a top-to-bottom length thereof. An aperture 21b extends through the bar 21 from right to left to cross the slit 21a.

An end (top end) of the lever 22 has the operating section 6 which is formed with a knob. The lever 22 has a narrowed portion 22a in an opposite side (lower side) to the end. A shaft aperture 22b into which the shaft 24 is inserted is pierced through an end part of the narrowed portion 22a. Also, a slot 22c is pierced through a mid part of the narrowed portion 22a. The narrowed portion 22a is inserted into the slit 4j of the basic body 4 and the slit 21a of the bar 21 so that the lever 22 is supported by the basic body 4 for pivotal movement through the shaft 24. More in detail, a bush 26 is inserted into the shaft aperture 22b. Then, the shaft 24 is inserted into the bush 26. Thereby, the lever 22 is supported by the basic body 4 for pivotal movement through the bush 26 and the shaft 24. The lever 22 is connected to the bar 21 by the pin 27 that extends through the slot 22c and the aperture 21b. The pin 27 can slide within the slot 22c relative to the lever 22. Thus, when the lever 22 is pivotally moved about an axis of the shaft 24, the bar 21 slides fore to aft along the guide hollow 4i. That is, the converting mechanism 23 that converts the pivotal movement of the lever 22 to the slide movement of the bar 21 is formed with the slot 22c which extends through the lever 22, the aperture 21b extending through the bar 21 and the pin 27.

Next, actions and effects of the clamping device 3 shown as the second embodiment will be described below. According to the clamping device 3, a workpiece 2 can be fixed in the following processes. The workpiece 2 is placed at a position in the fixing base 1 (specifically, the auxiliary base 1b) where the workpiece 2 is going to be fixed, the operating section 6 is operated (specifically, pivotally operated counterclockwise), and the pressing section 5 is moved (specifically, slid) from the standing-by position (see FIGS. 14 and 15) to the pressing position (see FIGS. 12 and 13) through the transmitting body 7 (lever 22 and the bar 21). Similarly to the first embodiment, at the pressing position, the first opposing sections 7a of the transmitting body 7 (specifically, the bar 21) receive the force generated by the pressurizing members 8a that are resiliently urged and are on the point of entering the first depressions 9b which belong to the pressurized surfaces 9a. Thereby, the pressing section 5 is urged to the side on which the pressing section 5 presses the workpiece 2. The pressing section 5 presses the workpiece 2 with the urging force so that the workpiece 2 is fixed to the fixing base 1 (specifically, the auxiliary base 1b).

Similarly to the first embodiment, because, when the pressing section 5 is placed at the pressing position, the pressing section 5 is urged to the side on which the pressing section 5 presses the workpiece 2 using the force by which the pressurizing members 8a, which are resiliently urged, are on the point of entering the first depressions 9b, the force by which the workpiece 2 is pressed can be kept constant regardless of any magnitude of the force generated by the hand operating the operating section 6. Also, the following effect can be expected. That is, because the conventional toggle clamp generates the force for pressing a workpiece by the force of a hand, the force generating work creates a burden on the worker. However, this burden can be reduced with the clamping device 3 because the clamping device 3 generates the force that presses the workpiece 2 using the force generated by the pressurizing members 8a that are resiliently urged by the leaf springs 10 and are on the point of entering the first depressions 9b (i.e., using the resilient force of the leaf springs 10). In addition, when the pressing section 5 is moved to the pressing position with the operating section 6 operated, the pressurizing members 8a, which are resiliently urged, are on the point of entering the first depressions 9b. Thereby, the pressing section 5 automatically moves to the pressing position to press the workpiece 2. Thus, the workpiece 2 can be surely fixed (clamped).

The bar 21 includes the first opposing sections 7a, 7a, each of which has the pressurized surface 9a, 9a, on both sides thereof which are symmetrically positioned to each other. The basic body 4 includes the second opposing sections 4a, each of which has the pressurizing member 8a, in correspondence to the first opposing sections 7a, 7a. Therefore, the balance of the bar 21 receiving the force of the pressurizing members 8a, 8a is maintained, and the bar 21 moves smoothly. In addition, because such two pairs of the pressurized surfaces 9a and the pressurizing members 8a are provided, the force by which the pressing section 5 presses the workpiece 2 can be greater to strongly fix the workpiece 2 to the fixing base 1 (specifically, the auxiliary base 1b).

On the other hand, the workpiece 2 can be removed from the fixing base 1 (specifically, the auxiliary base 1b) in the following processes. The operating section 6 is operated in the reverse direction (specifically, pivotally operated clockwise), the pressing section 5 is moved (specifically, slid) from the pressing position to the standing-by position through the transmitting body 7 (the lever 22 and the bar 21), and the workpiece 2 is removed from the fixing base 1 (specifically, the auxiliary base 1b). In a similar manner to the first embodiment, when the pressing section 5 is placed at the standing-by position, the pressurizing members 8a, which are resiliently urged, enter the second depressions 9c. Thereby, the pressing section 5 is kept at the standing-by position (see FIGS. 14 and 15).

Similarly to the first embodiment, each groove 9d formed in the respective pressurized surface 9a is sloped so as to be deeper as the groove 9d becomes closer to the second depression 9c than to the first depression 9b. In other words, each groove 9d is sloped so as to be shallower as the groove 9d becomes closer to the first depression 9b than to the second depression 9c. Therefore, in the process that the operating section 6 is operated to move the pressing section 5 from the standing-by position (see FIGS. 14 and 15) to the pressing position (see FIGS. 12 and 13), the leaf springs 10 (resilient members) gradually bend. Hence, the load exerting on the hand can be smaller in comparison with a situation such that the leaf springs 10 (resilient members) largely bend already when the pressing section 5 is at the standing-by position.

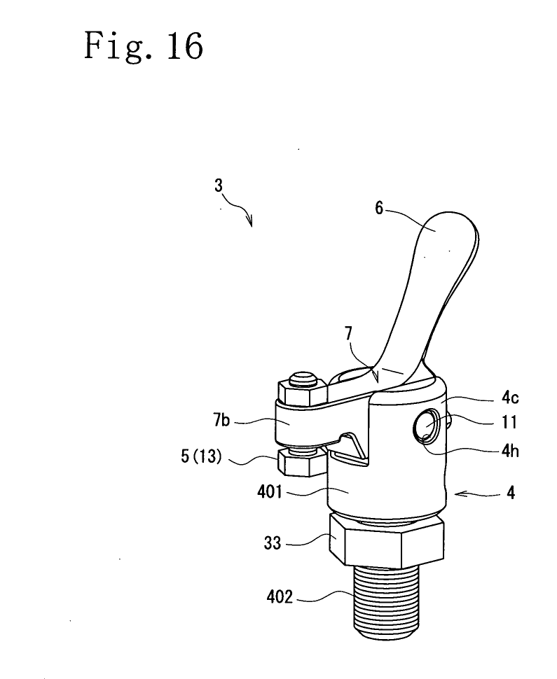

FIGS. 16-21 show a third embodiment of the invention. A clamping device 3 in this embodiment differs from the clamping device 3 in the first embodiment mainly in connection with arrangements of the first opposing section 7a and the second opposing section 4a and a means for resiliently urging the pressurizing members 8a. Because the other basic constructions are similar to those in the first embodiment, sections and members having the same functions will be assigned with the same reference numerals and symbols, and different portions will be mainly described below.

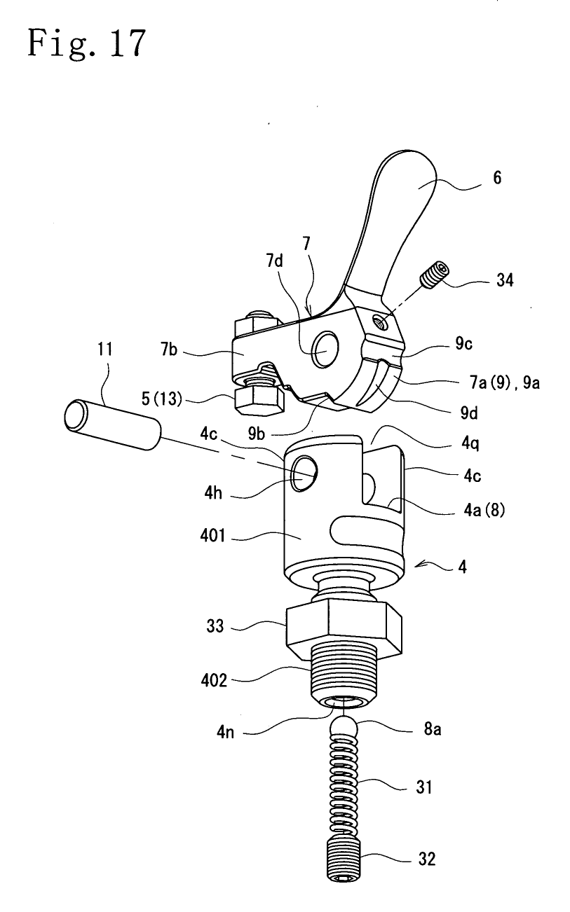

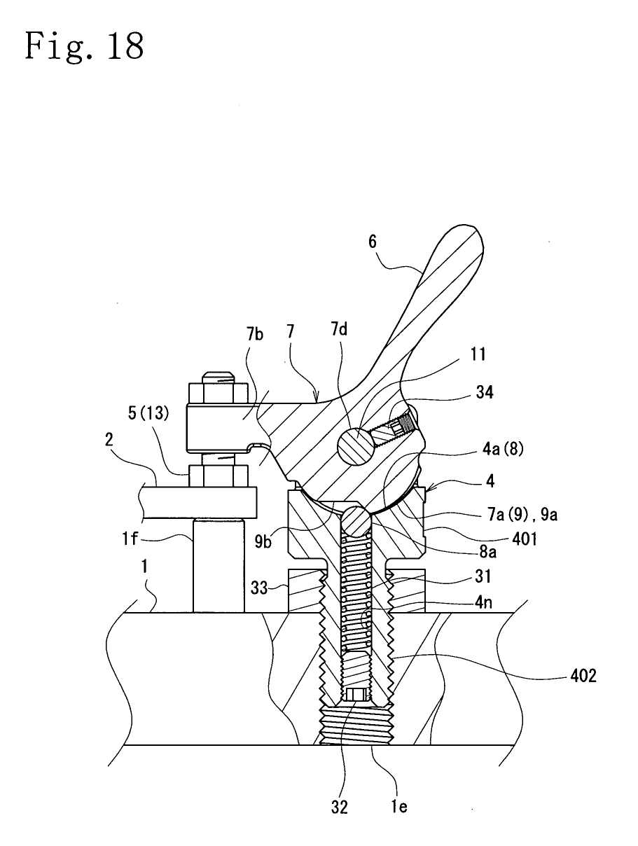

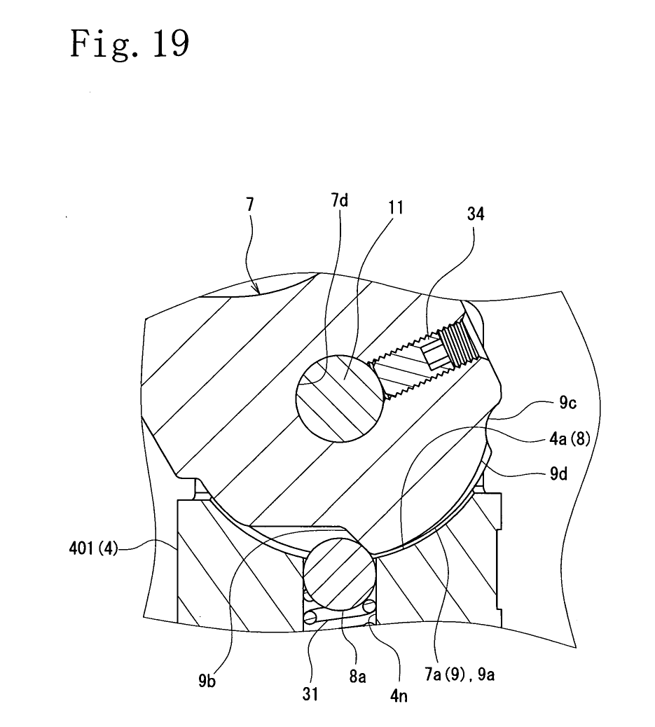

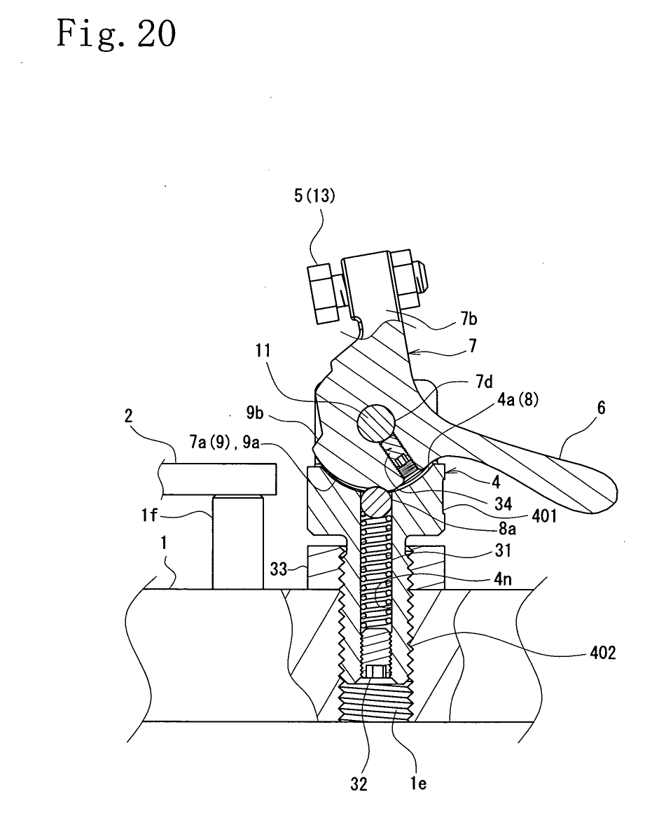

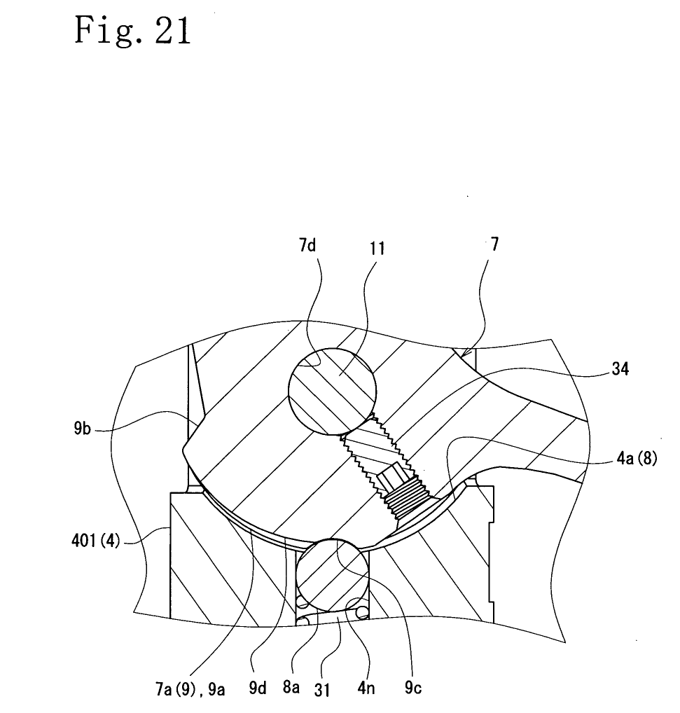

FIG. 16 is an oblique view of the clamping device 3. FIG. 17 is an exploded oblique view of the clamping device 3. FIG. 18 is a vertical cross-sectional view of the clamping device 3 when the pressing section 5 is placed at the pressing position and corresponds to FIG. 6 of the first embodiment. FIG. 19 is an enlarged principal portion view and corresponds to FIG. 7 of the first embodiment. FIG. 20 is a vertical cross-sectional view of the clamping device 3 when the pressing section 5 is placed at the standing-by position and corresponds to FIG. 8 of the first embodiment. FIG. 21 is an enlarged principal portion view and corresponds to FIG. 9 of the first embodiment.

A first opposing section 7a and a second opposing section 4a oppose to each other in a radial direction of a circle made about an axis around which a transmitting body 7 is supported by a basic body 4 for pivotal movement. The second opposing section 4a is one opposing section 8 and the first opposing section 7a is the remaining opposing section 9. The second opposing section 4a (the one opposing section 8) includes a pressurizing member 8a resiliently urged in a direction in which the pressurizing member 8a goes from the second opposing section 4a (the one opposing section 8) toward the first opposing section 7a (the remaining opposing section 9). The first opposing section 7a (the remaining opposing section 9) includes a pressurized surface 9a which the pressurizing member 8a pressurizes. The pressurizing member 8a is resiliently urged by a coil spring 31 as a resilient member. The basic body 4 includes a body part 401 and a mount part 402 extending from the body part 401 and screwed onto the fixing base 1. A holding hollow 4n for holding the pressurizing member 8a and the coil spring 31 extend through the body part 401 and the mount part 402.

Specifically, the basic body 4 includes the body part 401 having a generally cylindrical shape, and the mount part 402 extending in an axial direction of the body part 401 and threaded circumferentially to define a male screw therearound. The body part 401 has a recess 4q at an end thereof (in this embodiment, a top end). A bottom of the recess 4q defines the second opposing section 4a (in this embodiment, the one opposing section 8). Meanwhile, both side surfaces of the body part 401 interposing the recess 4q therebetween define rising portions 4c, 4c opposing to each other. A shaft aperture 4h extends through each rising portion 4c to support a shaft 11. The holding hollow 4n extending through the body part 401 and the mount part 402 is pierced vertically along axes of the body part 401 and the mount part 402 to open at the second opposing section 4a (the one opposing section 8). The pressurizing member 8a and the coil spring 31 are inserted into the holding hollow 4n. A bottom end of the holding hollow 4n is closed by a screw 32. The pressurizing member 8a is resiliently urged by the coil spring 31 to protrude into the recess 4q beyond the second opposing section 4a (the one opposing section 8). Additionally, the reference numeral 33 indicates a nut screwed onto the male screw of the mount part 402. The mount part 402 is screwed into a screw hole 1e of the fixing base 1 toward an appropriate depth, and the nut 33 is rotated until the nut 33 reaches the fixing base 1. Thereby, the mount part 402, and in turn, the clamping device 3 are mounted to the fixing base 1.

The transmitting body 7 is formed to be a plate shape generally having an arcuate circumferential surface. An arm 7b extends from one end of the transmitting body 7. A screw 13 forming the pressing section 5 is attached and fastened to the arm 7b. The other end of the transmitting section 7 has an operating section 6 projecting from the transmitting body 7. A shaft aperture 7d into which the shaft 11 is inserted extends through a center portion of the transmitting body 7. The transmitting body 7 is placed between the rising portions 4c, 4c of the basic body 4, i.e., within the recess 4q and is supported by the basic body 4 for pivotal movement through the shaft 11. More specifically, the shaft 11 is inserted into the shaft apertures 4h, 4h extended through the rising portions 4c, 4c and the shaft aperture 7d extending through the transmitting body 7 to extend therethrough. The shaft 11 is fixed to the transmitting body 7 by a set screw 34. Thus, the shaft 11 and the transmitting body 7 can pivot in unison about axes of the shaft apertures 4h, 4h of the basic body 4. Thereby, the transmitting body 7 is supported by the basic body 4 for pivotal movement.

The arcuate circumferential surface of the transmitting body 7 defines the first opposing section 7a (in this embodiment, the remaining opposing section 9). The first opposing section 7a (the remaining opposing section 9) has the pressurized surface 9a. The pressurized surface 9a includes a first depression 9b and a second depression 9c. A groove 9d extends between the first depression 9b and the second depression 9c to serve as a guide for the pressurizing member 8a. The groove 9d is sloped so as to be deeper as the groove 9d becomes closer to the second depression 9c than to the first depression 9b.

Actions and effects of the clamping device 3 are effectively the same as those of the first embodiment. The pressurizing member 8 is resiliently urged by the coil spring 31 as a resilient member. That is, the clamping device 3 generates the force that presses a workpiece 2 as an object using the force generated by the pressurizing member 8a that is resiliently urged by the coil spring 31 and is on the point of entering the first depression 9b (i.e., using the resilient force of the coil spring 31)(see FIG. 19). Additionally, in this embodiment, the workpiece 2 is not directly fixed to the fixing base 1. The workpiece 2 is fixed to the fixing base 1 through a support member if attached to the fixing base 1.

Because the holding hollow 4n extends through the body part 401 and the mount part 402, and the pressurizing member 8a and the coil spring 31 are inserted into the holding hollow 4n, the mount part 402 screwed into the fixing base 1 can be effectively used. Also, effectively using the mount part 40 as thus noted can contribute to downsizing of the clamping device 3.

The scope of this invention is not limited to the embodiment described above and can include various other modifications and variations. For example, the object can be a jig, a fixture, etc., other than a workpiece 2 which is an object for machining, measuring, etc.

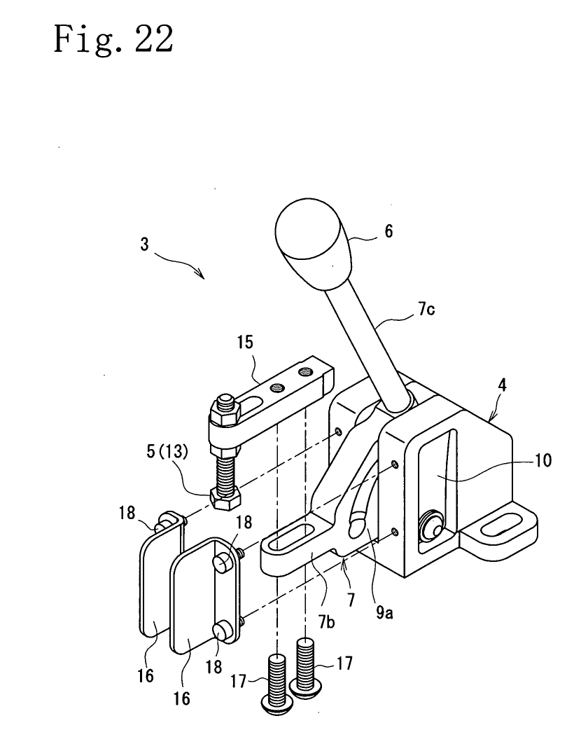

In the first embodiment, the screw 13 forming the pressing section 5 is attached to the arm 7b. However, as shown in FIG. 22, for example, an auxiliary arm 15 can be fastened to the arm 7b by screws 17, 17, and the screw 13 forming the pressing section 5 can be attached to the auxiliary arm 15. Also, in another variation, an end portion of the arm 7b and an end portion of the auxiliary arm 15 can be the pressing section without using the screw 13. In the variation shown in FIG. 22, covers 16, 16 are attached to the basic body 4 by, for example, screws 18, 18 to cover the pressurized surfaces 9a, 9a of the transmitting body 7. Preferably, similar covers are used in the clamping device 3 of the first embodiment. However, such covers 16 are not necessarily prepared separately from the basic body 4 and can be unitarily formed with the basic body 4.

Although the pressurized surface 9a has the second depression 9c and the groove 9d, one of them or both of them are dispensable.

In the first and second embodiments, the clamping device 3 has two sets of the combination of the pressurized surface 9a and the pressurizing member 8a. However, one set of them can be applicable and even three sets or more sets can be applicable. On the other hand, in the third embodiment, the clamping device 3 has one set of the combination of the pressurized surface 9a and the pressurizing member 8a. However, two or more sets can be applicable.

Although, in the second embodiment, the bar 21 has the first opposing sections 7a, the lever 22, instead, can have the first opposing sections 7a.

In every embodiment described above, the second opposing section 4a that belongs to the basic body 4 defines the one opposing section 8 having the pressurizing member 8a, and the first opposing section 7a that belongs to the transmitting body 7 defines the remaining opposing section 9 having the pressurized surface 9a. However, conversely, the first opposing section 7a can define the one opposing section 8, and the second opposing section 4a can define the remaining opposing section 9. In other words, the transmitting body 7 can have the pressurizing member 8a, and the basic body 4 can have the pressurized surface 9a.

In the second embodiment, the converting mechanism 23 that converts the pivotal movement of the lever 22 to the slide movement of the bar 21 is formed with the slot 22c extending through the lever 22, the aperture 21b extending through the bar 21, and the pin 27. However, the converting mechanism 23 can be formed with other linkage mechanisms, cam mechanisms, etc.

The operating section 6 can utilize any movements other than the pivotal movement, such as, for example, slide movement.

The transmitting body 7 can take the form of any structures, if such structures can transmit the movement of the operating section 6 to the pressing section 5.

In the first and second embodiments, the leaf spring 10 can be formed with a single piece or can be formed with stacked multiple pieces. The force with which the pressing section 5 presses the workpiece 2 is adjustable by changing the number of sheets of the leaf springs 10.

The resilient members such as the leaf spring 10 and the coil spring 31 are used as the urging means for resiliently urging the pressurizing member 8a. However, other resilient members can be used. In the first and second embodiments, the pressurizing member 8a is provided separately from the leaf spring 10 (resilient member). However, the pressurizing member 8a can be provided unitarily with the leaf spring 10 (resilient member) in such a manner, for example, that a projection functioning as the pressurizing member is formed at an end of the leaf spring 10 (resilient member).

### DESCRIPTION OF REFERENCE NUMERALS AND SYMBOLS

2: workpiece (object)
3: clamping device
4: basic body
4a: second opposing section
5: pressing section
6: operating section
7: transmitting body
7a: first opposing section
8: one opposing section
8a: pressurizing member
9: remaining opposing section
9a: pressurized surface
9b: first depression
9c: second depression
9d: groove
21: bar
22: lever
23: converting mechanism
31: coil spring
401: body part
402: mount part
4n: holding hollow

What is claimed is:

1. A clamping device for fixing an object, comprising:
a basic body;
a pressing section for pressing the object;
a manually operable operating section; and
a transmitting body mounted to the basic body for transmitting a movement of the operating section to the pressing section so that the pressing section travels between a pressing position at which the pressing section presses the object, and a standing-by position at which the pressing section is spaced apart from the object to stand by, the transmitting body including a first structural portion defining at least one first opposing section, wherein
the basic body includes at least one second opposing section opposing said at least one first opposing section in a direction normal to a direction in which the at least one first opposing section moves,
a selected one of said at least one first opposing section or said at least one second opposing section includes a pressurizing member resiliently urged in a direction in which the pressurizing member goes from the one of said at least one first opposing section or said at least one second opposing section toward a remaining selected one of said at least one first opposing section or said at least one second opposing section, the remaining one of said at least one first opposing section or said at least one second opposing section including a pressurized surface which the pressurizing member pressurizes, and
the pressurized surface includes a first depression which the pressurizing member is on the point of entering when the pressing section is placed at the pressing position, the first opposing section receives the force generated by the pressurizing member that is on the point of entering the first depression so that the pressing section is urged to a side on which the pressing section presses the object.

2. The clamping device according to claim 1, wherein the pressurized surface includes a second depression which the pressurizing member enters when the pressing section is placed at the standing-by position.

3. The clamping device according to claim 1 or 2, wherein:
the pressing section and the operating section are unitarily formed with the transmitting body, and
the transmitting body is supported by the basic body for pivotal movement so that the pressing section travels between the pressing position and the standing-by position.

4. The clamping device according to claim 3, wherein:
said at least one second opposing section is the selected one of said at least one first opposing section or said at least one second opposing section, and said at least one first opposing section is the remaining selected one of said at least one first opposing section or said at least one second opposing section, and
said at least one first opposing section includes first opposing sections, each of which includes the pressurized surface, on both sides thereof which are symmetrically positioned to each other, and said at least one second opposing section includes second opposing sections, each of which includes the pressurizing member, corresponding to the first opposing sections.

5. The clamping device according to claim 1 or 2, wherein:
the transmitting body has a bar including the pressing section at an end thereof, and a lever including the operating section at an end thereof,
the bar is supported by the basic body for slide movement so that the pressing section travels between the pressing position and the standing-by position,
the lever is mounted to the basic body for pivotal movement, and
a converting mechanism arranged to convert the pivotal movement of the lever to the slide movement of the bar is placed between the lever and the bar.

6. The clamping device according to claim 5, wherein:
said at least one second opposing section is the selected one of said at least one first opposing section or said at least one second opposing section, and said at least one first opposing section is the remaining selected one of said at least one first opposing section or said at least one second opposing section, and
the bar includes said at least one first opposing section, said at least one first opposing section including first opposing sections, each of which includes the pressurized surface, on both sides thereof which are symmetrically positioned to each other, and the basic body includes said at least one second opposing section, said at least one second opposing section including second opposing sections, each of which includes the pressurizing member, corresponding to the first opposing sections.

7. The clamping device according to claim 2, wherein the pressurized surface has a groove extending between the first depression and the second depression to be a guide for the pressurizing member, and the groove is sloped so as to be deeper as the groove becomes closer to the second depression than to the first depression.

8. The clamping device according to claim 3, wherein the first opposing section and the second opposing section oppose each other in a radial direction of a circle made about an axis around which the transmitting body is supported by the basic body for pivotal movement.

9. The clamping device according to claim 8, wherein:
the second opposing section is the one of the first or second opposing sections and the first opposing section is the remaining one of the first or second opposing sections, and
the pressurizing member is resiliently urged by a coil spring.

10. The clamping device according to claim 9, wherein the basic body includes a body part and a mount part extending from the body part and adapted to be screwed onto a fixing base, and
a holding hollow for holding the pressurizing member and the coil spring extends through the body part and the mount part.
